(19) United States
(12) Patent Application Publication
(10) Pub. No.: US 2023/0168142 A1
(43) Pub. Date: Jun. 1, 2023

(54) INPUT/OUTPUT PORTS

(71) Applicant: HEWLETT-PACKARD DEVELOPMENT COMPANY, L.P., SPRING, TX (US)

(72) Inventors: YOW WEI CHENG, TAIPEI CITY (TW); CHIA-WEI TING, TAIPEI CITY (TW); KUANG-CHUN CHEN, TAIPEI CITY (TW)

(73) Assignee: HEWLETT-PACKARD DEVELOPMENT COMPANY, L.P., SPRING, TX (US)

(21) Appl. No.: 17/997,949

(22) PCT Filed: Jun. 19, 2020
(86) PCT No.: PCT/US2020/038697

§ 371 Date: Nov. 4, 2022

(51) Int. Cl. G01M 1/22; H04R 1/08; H04R 1/02; H04R 3/00; G06F 1/20

(52) U.S. Cl. CPC G01M 1/22; H04R 1/08; H04R 1/028; H04R 3/00; G06F 1/203; H04R 2499/15

(57) ABSTRACT

Example electronic devices for detecting whether a fan of the electronic device is malfunctioning are disclosed. In an example, the electronic device includes a housing, a fan to generate an airflow within the housing, and a microphone coupled to the housing. In addition, the electronic device includes a controller coupled to the microphone and the fan. The controller is to use the microphone to record a fan noise emitted by the fan, and determine whether the fan is malfunctioning based on the fan noise.

### BACKGROUND

An electronic device may include a fan that is to generate an airflow within a housing of the electronic device so as to maintain a desired temperature within the housing during operations. As the fan is rotating, noise is created by the components of the fan and/or the airflow generated via operation of the fan. In some cases, the noise created by the fan may be audible to a user.

### BRIEF DESCRIPTION OF THE DRAWINGS

Various examples will be described below referring to the following figures:

FIG. 1 shows a schematic side view of an electronic device according to some examples;

FIG. 2 shows a schematic system diagram of a controller, a microphone, and a fan of the electronic device of FIG. 1 according to some examples; and

FIGS. 3 and 4 show flow diagrams of example machine-readable instructions for determining whether a fan of an electronic device is malfunctioning according to some examples.

### DETAILED DESCRIPTION

Electronic device fans generate noise (which may be referred to herein as “fan noise”). The fan noise may be audible, and may, in some cases, cause concern for a user of the electronic device. However, a determinative diagnosis of a malfunction in the fan may include inspection by trained personnel at a suitable repair facility (e.g., manufacturing location, repair shop, etc.). The shipment of the electronic device to the repair facility and the subsequent inspection and repair process may take a considerable amount of time and carry expense for the electronic device manufacturer and/or the user (e.g., shipping costs, equipment costs, personnel time, etc.).

Accordingly, examples disclosed herein include electronic devices that perform a self-diagnostic routine so as to determine whether a fan (or fans) of the electronic device are operating normally or are malfunctioning. Through use of the example electronic devices disclosed herein, a user may run a diagnostic for the fan if a user becomes concerned that a fan is not functioning properly (e.g., due to the fan noise produced by the fan during operation).

If the electronic device determines that the fan is malfunctioning via the self-diagnostic routine, the user may then proceed to contact the manufacturer or repair service for further inspection and repairs as appropriate. However, if the electronic device determines that the fan is not malfunctioning, the user may proceed with normal operations and avoid the time and expense associated with further inspection and repair services as noted above. Therefore, through use of the examples disclosed herein, instances of unnecessary or unwarranted inspection and repair services stemming from a perceived malfunction of an electronic device fan may be avoided.

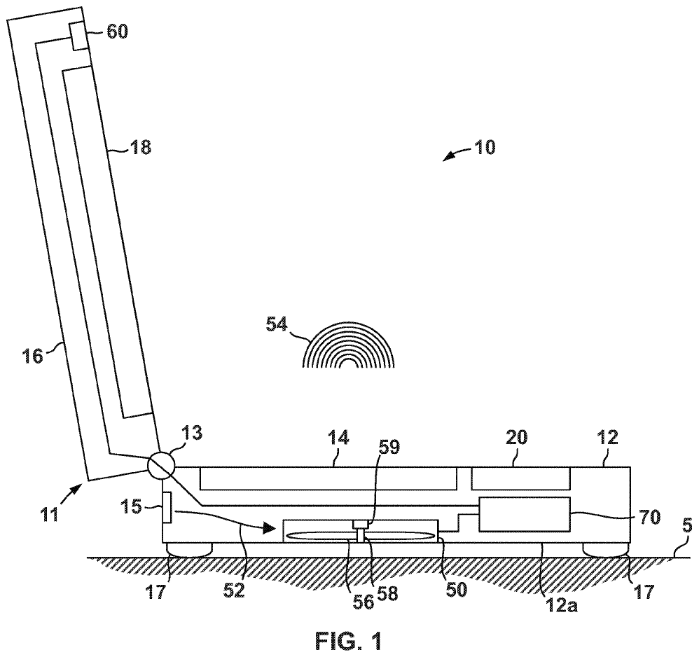

Referring now to FIG. 1, an electronic device 10 according to some examples is shown. As used herein, the term “electronic device” refers to a device that is to execute machine readable instructions, and may include internal components such as processors, power sources, memory devices, etc. The term specifically includes laptop computers, desktop computers, tablet computers, all-in-one computers, smartphones, etc. In the example of FIG. 1, electronic device 10 is a laptop computer that includes a housing 11 comprising a first housing member 12 and a second housing member 16 rotatably coupled to one another at a hinge 13. The first housing member 12 includes a plurality of user input devices, such as, for example, a keyboard 14 and a trackpad 20. The second housing member 16 includes a display 18 (e.g., a liquid crystal display (LCD), a plasma display, an organic light emitting diode (OLED) display, etc.) that is to display images (not shown) for viewing by a user.

First housing member 12 may engage with or oppose a support surface 5 for the electronic device 10. Support surface 5 may comprise any suitable surface, such as, for instance, a desk, table, countertop, floor, user's lap, etc. The first housing member 12 may include a foot or feet 17 that may engage with support surface 5 to thereby elevate some or all of a bottom surface 12a of first housing member 12 above support surface 5 during operations.

Second housing member 16 includes a microphone 60. Microphone 60 may comprise a single microphone or a microphone array. Regardless, during operations, microphone 60 is to receive sound waves and convert them into electrical signals for subsequent communication and processing as described herein. In some examples, microphone 60 may be utilized by the electronic device 10 to record sounds associated with videos, voice memos, other sound recordings, etc. In some examples, microphone 60 may be coupled to or integrated with a video camera (not specifically shown) that may take images (e.g., still images, video, etc.) that may be associated with sound recordings captured by microphone 60. In some examples (e.g., such as the example of FIG. 1), the microphone 60 is disposed along a top most side of the display 18; however, it should be appreciated that the precise location of microphone 60 may be varied in different examples.

A controller 70 is disposed within housing 11 and is coupled to microphone 60. Controller 70 may be disposed within first housing member 12 or second housing member 16 in various examples; however, in the example of FIG. 1, controller 70 is disposed within first housing member 12. In some examples, controller 70 may be disposed within both first housing member 12 and second housing member 16, such that a first portion of controller 70 is disposed within first housing member 12 and a second portion of controller 70 is disposed within second housing member 16.

Referring still to FIG. 1, in addition, first housing member 12 may include a fan 50 that is to generate an airflow 52 within first housing member 12 so as to cool electronic components disposed therein (e.g., a central processing unit, graphics processing unit, memory, etc.). The fan 50 may generate airflow 52 by pushing air into the first housing member 12 (e.g., at the bottom surface 12a) or pulling air through the first housing member 12 from another opening (or openings) 15 therein. Regardless, heat that is generated by the various electronic components within first housing member 12 may be transferred out of the first housing member 12 by the airflow 52 during operations.

Fan 50 includes an impeller 56 that is rotated by a driver 59 via a shaft 58. The driver 59 may comprise any suitable prime mover, such as, for instance, an electric motor. During operations, driver 59 may rotate impeller 56 so as to generate the airflow 52. During this process, vibrations resulting from the rotation of impeller 56, shaft 58, driver 59, etc. may generate fan noise 54. In some examples, the airflow 52 (particularly, vibrations produced thereby) may cause or contribute to fan noise 54.

As previously described, in some cases, fan noise 54 may be audible to a user of electronic device 10. The fan noise 54 may cause concern for the user. Specifically, the user may believe that fan 50 is malfunctioning as a result of the fan noise 54.

Accordingly, controller 70 is coupled to fan 50 (e.g., to driver 59) and may perform a self-diagnostic of fan 50 so as to determine whether fan 50 is malfunctioning based on the fan noise 54. In particular, controller 70 may use the microphone 60 to record a fan noise 54. In addition, controller 70 may compare the recorded fan noise 54 with a reference fan noise, and then determine, based on this comparison, whether the fan 50 is malfunctioning. Further details of controller 70 and this self-diagnostic routine are described in more detail below.

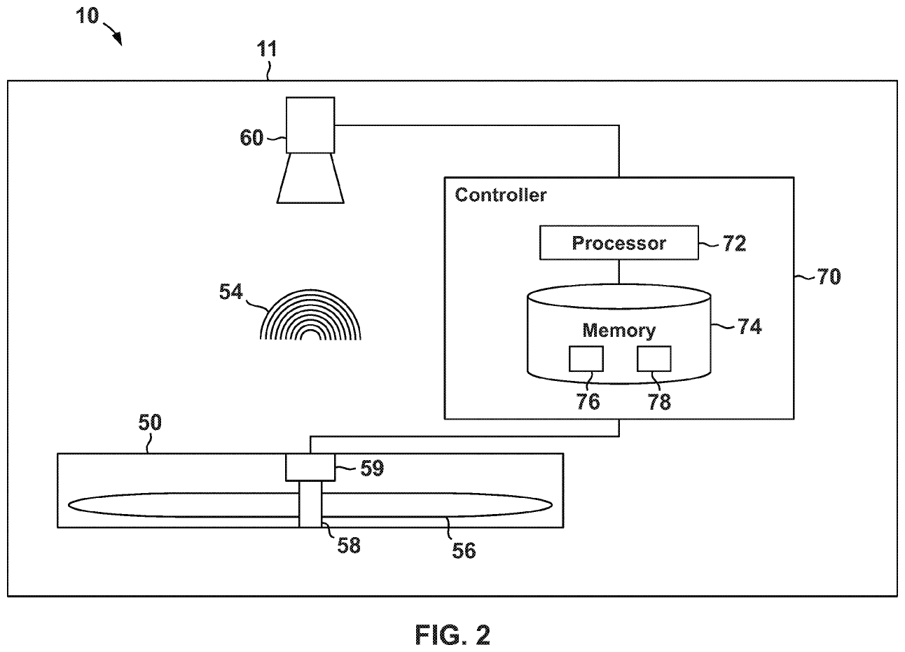

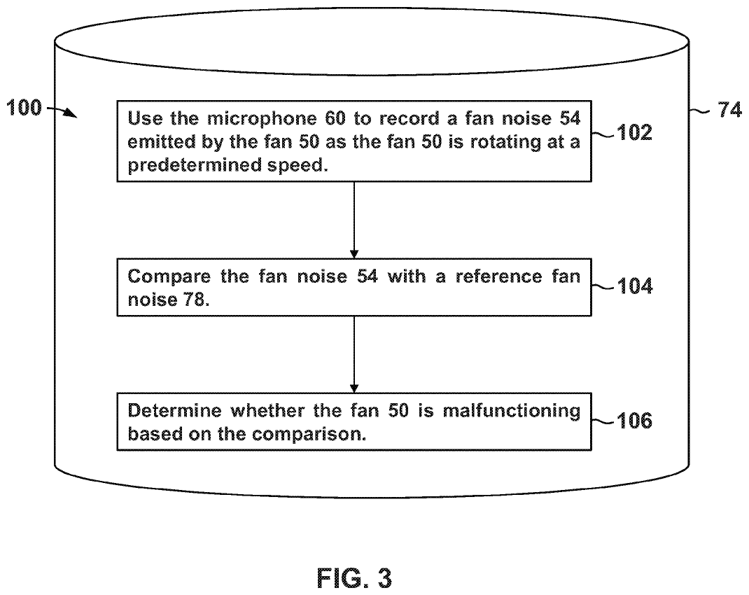

Reference is now generally made to FIGS. 2 and 3. In particular, FIG. 2 shows a schematic system diagram of electronic device 10 (with a limited, schematic depiction of microphone 60, fan 50, and controller 70). As shown, controller 70 generally includes a processor 72 and a memory 74. The processor 72 (e.g., microprocessor) executes machine-readable instructions 76 stored on memory 74 (e.g., a non-transitory machine-readable medium). The memory 74 may comprise volatile storage (e.g., random access memory (RAM)), non-volatile storage (e.g., flash storage, etc.), or combinations of both volatile and non-volatile storage. Data read or written by the processor 72 when executing the machine-readable instructions 76 can also be stored on memory 74. In addition, a reference fan noise 78 (which is described in more detail below) may also be saved on memory 74. In some instances, controller 70 may be incorporated within a general control assembly of the electronic device 10, or may be a stand-alone control assembly for performing a diagnostics routine for fan 50.

FIG. 3 shows example machine-readable instructions 100 that may be performed by controller 70 to determine whether fan 50 is malfunctioning. Thus, machine-readable instructions 100 may represent examples of a self-diagnostic routine for fan 50 as previously described above. In some examples, the machine-readable instructions 100 may be saved on memory 74 as an example of machine-readable instructions 76 that may be executed by processor 72 (see e.g., FIG. 2). In describing the features of machine-readable instructions 100, continuing reference will be made to the schematic depiction of electronic device 10 in FIG. 2, so as to provide clarity.

Referring still to FIGS. 2 and 3, at block 102, machine-readable instructions 100 include using the microphone 60 to record a fan noise 54 emitted by the fan 50 as the fan 50 is rotating at a particular speed. For instance, controller 70 may directly or indirectly (e.g., via another controller or control assembly within electronic device 10—see e.g., FIG. 1) actuate the fan 50 (e.g., via driver 59) to rotate the impeller 56 at a particular speed (e.g., which may be measured in revolutions per minute (RPM)). In some examples, the controller 70 may actuate the fan 50 (e.g., again either directly or indirectly) to rotate (e.g., via the driver 59) at a plurality of particular speeds (e.g., such as speeds corresponding with slow, medium, and fast rotation of the impeller 56 in some examples). Simultaneously, at block 102, controller 70 may use the microphone 60 to record the resulting fan noise 54. The microphone 60 may capture fan noise 54 and generate a corresponding electrical signal that is communicated (e.g., via a wired and/or wireless path) to controller 70.

Referring briefly again to FIG. 1, in some examples (e.g., such as for the example electronic device 10 of FIG. 1), prior to block 102, controller 70 may also prompt a user to place the second housing member 16 in a particular rotative position (or range of rotative positions) about the hinge 13 relative to first housing member 12 so as to place the microphone 60 at a desired distance, angle, position, etc. relative to the fan 50. For instance, in some examples, controller 70 may prompt the user to place the second housing member 16 such that an angle between the first housing member 12 and second housing member 16 is approximately 90° (or from about 60° to about 100°). Without being limited to this or any other theory, by prompting the user to place the second housing member 16 in a particular position relative to first housing member 12, variations or anomalies in the recording of fan noise 54 by microphone 60 caused by different placements or positions of the microphone 60 relative to the fan 50 may be reduced or eliminated.

Referring again to FIGS. 2 and 3, in some examples, controller 70 may condition the performance of machine-readable instructions 100 on the characteristics of the background noise of the environment surrounding electronic device 10. For instance, upon receiving a request to perform machine-readable instructions 100 (e.g., from a user, another controller or processor, etc.), controller 70 may obtain an initial recording (or multiple recordings) with the microphone 60 while the fan 50 is not operating so as to determine the background noise. If the level (e.g., sound pressure level) or the background noise and/or a time-dependent variance of the background noise is too high (e.g., is above a threshold) then controller 70 may avoid execution of machine-readable instructions 100, and may, in some examples, produce an instruction (e.g., via display 18 in FIG. 1) to the user to move to a quieter environment before proceeding with the self-diagnostic (e.g., machine-readable instructions 100).

Machine-readable instructions 100 also include comparing the fan noise 54 with a reference fan noise 78 at block 104. The reference fan noise 78 may comprise a recorded fan noise that is saved on memory 74 as generally shown in FIG. 2. Generally speaking, the reference fan noise 78 may comprise a fan noise associated with a normal operation of the fan 50 within electronic device 10 (see e.g., FIG. 1). The reference fan noise 78 may comprise a so-called normal fan noise produced by the fan 50 (e.g., within the electronic device 10 in FIG. 1) during rotation of the impeller 56 at a particular speed or at a plurality of particular speeds. In some examples, the particular speed(s) of the fan 50 (particularly impeller 56) associated with the reference fan noise 78 may correspond (e.g., may be equal, proportional to, etc.) to the particular speed(s) for the fan 50 previously described above for block 102. Example methods for obtaining, processing, and storing the reference fan noise 78 are described in more detail below; however, generally speaking, the reference fan noise 78 may be obtained under controlled conditions when fan 50 is verified to be operating normally (i.e., when fan 50 is not malfunctioning).

In some examples, controller 70 may process the recording of fan noise 54 captured by microphone 60 to determine a parameter or parameters associated with the fan noise 54. For instance, in some examples, the parameter or parameters of fan noise 54 may comprise a sound pressure curve and/or a sound pressure level for the recorded fan noise 54.

A sound pressure level may comprise a value representing the magnitude of a sound pressure of a corresponding sound (e.g., fan noise 54) relative to a reference sound. Sound pressure levels are measured in decibels (dB). By contrast, a sound pressure curve comprises a range of sound pressure levels across a range or spectrum of frequencies. Thus, a sound pressure level may provide information relating to how loud a particular sound is at a particular frequency, while a sound pressure curve may provide information relating to how loud a particular sound is over a range of frequencies.

Accordingly, in some examples, at block 104, controller 70 may compute a sound pressure level (e.g., such as a maximum sound pressure level within a designated frequency range), and/or a sound pressure curve for the recorded fan noise 54 from block 102. Thereafter, the controller 70 may compare these parameter(s) of the recorded fan noise 54 with corresponding parameter(s) of the reference fan noise 78. Specifically, in some examples, controller 70 may compare the fan noise 54 and reference fan noise 78 by determining whether parameter(s) of the fan noise 54 is/are within a particular range of the corresponding parameter(s) of the reference fan noise 78. In some examples, controller 70 may determine whether an error (e.g., a difference or absolute value thereof) between the sound pressure levels and/or sound pressure curves of the fan noise 54 and reference fan noise 78 is greater than or equal to a particular threshold.

In some examples, a plurality of recordings of the fan noise 54 may be captured by the microphone 60 at block 102 (e.g., again at a particular speed or plurality of particular speeds). In some of these examples, a parameter or parameters of the fan noise 54 may then be computed as an average parameter or parameters across the plurality of recordings. For instance, a sound pressure level (e.g., a maximum sound pressure level) and/or a sound pressure curve may be computed for each recording of the plurality of recordings, and then an average sound pressure level and/or an average sound pressure curve may be computed for the plurality of recordings. These average values (e.g., the average sound pressure level and/or average sound pressure curve) may then be compared with the corresponding parameter(s) of reference fan noise 78 as previously described above.

In some examples, a background noise may be removed from the recording or plurality of recordings of fan noise 54. For instance, a first recording may be obtained using the microphone 60 without operating the fan 50. A second recording may also be obtained using the microphone 60, but with the fan 50 operating as previously described above. The background noise, which may comprise a noise of the surrounding environment as previously described, may be captured from the first recording (when the fan 50 is not operating), and then subsequently subtracted from the second recording (when the fan 50 is operating) so as to isolate the fan noise 54 within the second recording. A similar process may be carried out to remove the background noise from a plurality of recordings of fan noise 54 as noted above. In some of these examples, a single recording of the background noise (e.g., without operating the fan 50) may be utilized to subtract the background noise from the plurality of recordings of fan noise 54.

As previously described, the reference fan noise 78 may be obtained under controlled conditions and when fan 50 is verified to be functioning properly. In particular, in some examples, reference fan noise 78 may be obtained at a manufacturing site, research facility (e.g., lab), or other suitable controlled environment. In some examples, reference fan noise 78 may be obtained using electronic device 10 or another electronic device that is constructed in the same or similar manner to electronic device 10.

More specifically, reference fan noise 78 may comprise a recording (or parameter(s) thereof) of fan 50 of electronic device 10 (or a similarly constructed electronic device as previously described) via the microphone 60. Proper operation of fan 50 may first be verified through suitable testing and inspection, so as to ensure that the reference fan noise 78 is representative of a normal fan noise for fan 50. In some examples, the reference fan noise 78 may comprise computed parameter(s) obtained from the controlled recording of a properly operating fan 50, such as, for instance sound pressure level(s) and/or sound pressure curve(s). When obtaining the reference fan noise 78, similar techniques for removing background noise and generating average parameter(s) across a plurality of recordings may be utilized in the manner previously described above for fan noise 54. Thus, a detailed description of these techniques is not repeated herein, in the interests of brevity.

Once the reference fan noise 78 is obtained, it is then stored on memory 74 of controller 70 as a raw recording, as a parameter or parameters of a raw recording (e.g., sound pressure level(s), sound pressure curve(s), etc.), or both. Thus, during a subsequent performance of block 104 of machine-readable instructions 100, the controller 70 may compare the reference fan noise 78 to subsequent recordings of the fan noise 54 as previously described above.

Referring still to FIGS. 2 and 3, machine-readable instructions 100 also include, at block 106, determining whether the fan 50 is malfunctioning based on the comparison (e.g., from block 104). For instance, the comparison between the fan noise 54 and reference fan noise 78 may comprise computing an error between corresponding parameter(s) of the fan noise 54 and reference fan noise 78 as previously described. This error may then be used by the controller 70 to determine whether the fan 50 is malfunctioning at block 106. For instance, if the error between corresponding parameters of the fan noise 54 and reference fan noise 78 (e.g., the sound pressure levels and/or the sound pressure curves) is equal to or greater than the threshold, then controller 70 may determine that the recorded fan noise 54 is abnormal and therefore that the fan 50 may be malfunctioning. If, on the other hand, the error between the parameters (e.g., the sound pressure levels and/or sound pressure curves) is below the threshold, then controller 70 may determine that the recorded fan noise 54 is normal and therefore that the fan 50 is not malfunctioning.

If controller 70 determines that fan 50 is malfunctioning as a result of block 106, controller 70 may then alert the user (e.g., via display 18 in FIG. 1) that further testing and inspection of fan 50 at a designated repair facility may be necessary. If, on the other hand, controller 70 determines that fan 50 is not malfunctioning as a result of block 106, controller 70 may inform user (e.g., again via display 18 in FIG. 1) that fan 50 is operating normally such that further testing or inspection is not necessary.

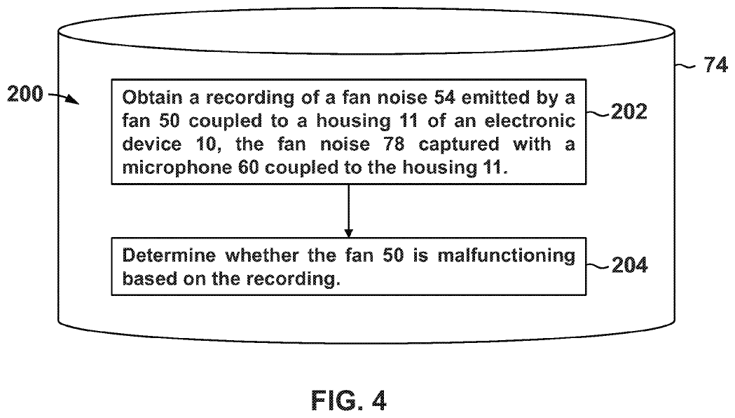

Referring now to 4, an example of machine-instructions 200 for determining whether a fan of an electronic device is malfunctioning is shown. Thus, machine-readable instructions 200 may represent examples of a self-diagnostic routine for a fan of an electronic device as previously described above. In some examples, the machine-readable instructions 200 may be saved on memory 74 as an example of machine-readable instructions 76 that may be executed by processor 72 (see e.g., FIG. 2). In describing the features of machine-readable instructions 200 in FIG. 4, continuing reference will be made to the schematic depiction of electronic device 10 in FIG. 2, so as to provide clarity.

Machine-readable instructions 200 include obtaining a recording of a fan noise 54 emitted by a fan 50 coupled to a housing 11 of an electronic device 10, the fan noise 78 captured with a microphone 60 coupled to the housing 11 at block 202. For instance, as previously described above, the microphone 60 may capture fan noise 54 and generate a corresponding electrical signal that is communicated (e.g., via a wired and/or wireless path) to controller 70.

In addition, machine-readable instructions 200 also include determining whether the fan 50 is malfunctioning based on the recording at block 204. For instance, as previously described above, controller 70 may determine whether fan 50 is malfunctioning based on the recording of the fan noise 54 in the manner previously described above (e.g., via a comparison of the fan noise 54 with a reference fan noise 78). In some examples, machine-readable instructions 200 may include various processing and analyzing methods previously described above for machine-readable instructions 100 (e.g., removal of background noise, obtaining a plurality of recordings of fan noise 54, computing parameter(s) of the fan noise 54, etc.).

Accordingly, the examples disclosed herein include electronic devices that may perform a self-diagnostic routine so as to determine whether a fan of the electronic device is operating normally or is malfunctioning. Therefore, through use of the examples disclosed herein, instances of unnecessary or unwarranted inspection and repair services stemming from a perceived malfunction of an electronic device fan may be avoided.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the discussion above and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections.

As used herein, including in the claims, the word “or” is used in an inclusive manner. For example, “A or B” means any of the following: “A” alone, “B” alone, or both “A” and “B.”

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An electronic device, comprising:
a housing;
a fan to generate an airflow within the housing;
a microphone coupled to the housing; and
a controller coupled to the microphone and the fan, wherein the controller is to:
use the microphone to record a fan noise emitted by the fan; and
determine whether the fan is malfunctioning based on the fan noise.

2. The electronic device of claim 1, wherein the controller is to:
compare the fan noise with a reference fan noise; and
determine whether the fan is malfunctioning based on the comparison.

3. The electronic device of claim 2, wherein the controller is to compare a sound pressure level of the fan noise with a sound pressure level of the reference fan noise.

4. The electronic device of claim 2, wherein the controller is to compare a sound pressure curve of the fan noise with a sound pressure curve of the reference fan noise.

5. The electronic device of claim 1, wherein the controller is to remove a background noise from the fan noise.

6. The electronic device of claim 5, wherein the controller is to:
use the microphone to obtain a first recording while the fan is not rotating;
determine the background noise from the first recording;
use the microphone to obtain a second recording while the fan is rotating; and
subtract the background noise from the second recording.

7. An electronic device, comprising:
a housing;
a fan to generate an airflow within the housing;
a microphone coupled to the housing;
a memory disposed within the housing; and
a processor disposed within the housing and coupled to the memory, and the microphone, the processor to:
use the microphone to record a fan noise emitted by the fan as the fan is rotating at a particular speed;
compare the fan noise with a reference fan noise stored in the memory; and
determine whether the fan is malfunctioning based on the comparison.

8. The electronic device of claim 7, wherein the processor is to determine an error between a first feature of the fan noise and a second feature of the reference fan noise, and wherein the processor is to determine that the fan is malfunctioning when the error is equal to or greater than a threshold.

9. The electronic device of claim 8, wherein the first feature comprises a sound pressure level of the fan noise, and wherein the second feature comprises a sound pressure level of the reference fan noise.

10. The electronic device of claim 8, wherein the first feature comprises a sound pressure curve of the fan noise, and wherein the second feature comprises a sound pressure curve of the reference fan noise.

11. The electronic device of claim 8, wherein the processor is to remove a background noise from the fan noise.

12. A non-transitory, machine-readable medium, storing instructions, which, when executed by a processor of an electronic device, cause the processor to:
obtain a recording of a fan noise emitted by a fan coupled to a housing of an electronic device, the fan noise captured with a microphone coupled to the housing; and
determine whether the fan is malfunctioning based on the recording.

13. The non-transitory, machine-readable medium of claim 12, wherein the instructions, when executed by the processor, cause the processor to:
compare the fan noise with a reference fan noise; and
determine whether the fan is malfunctioning based on the comparison.

14. The non-transitory, machine-readable medium of claim 13, wherein the instructions, when executed by the processor, cause the processor to remove a background noise from the recording.

15. The non-transitory, machine-readable medium of claim 13, wherein the instructions, when executed by the processor, cause the processor to compare a sound pressure level or sound pressure curve of the fan noise to a sound pressure level or sound pressure curve, respectively, of the reference fan noise.
